(19) United States
(12) Patent Application Publication
(10) Pub. No.: US 2026/0083232 A1
(43) Pub. Date: Mar. 26, 2026

(54) Implement Support Assembly and System for an Implement

(71) Applicant: Zadro, Inc., Huntington Beach, CA (US)

(72) Inventor: Zlatko Zadro, Huntington Beach, CA (US)

(73) Assignee: Zadro, Inc., Huntington Beach, CA (US)

(21) Appl. No.: 18/897,354

(22) Filed: Sep. 26, 2024

(51) Int. Cl. A45D 42/16

(52) U.S. Cl. CPC A45D 42/16

(57) ABSTRACT

A handle assembly for an implement is provided herein as a hand-held mirror to permit a user to easily switch between a hand-held configuration and a surface-supported configuration. A handle component is sheathed at least partially by a detachable implement support component in the hand-held configuration to permit the user to manually grasp the implement by the handle assembly. The handle component is inserted through a handle opening formed through the implement support component with the implement support component arranged transversely to the handle component in the surface-supported configuration to permit the handle assembly to rest on a support surface. Further, the handle opening can be positioned at discrete positions along the handle component to position the implement at differing angles and heights.

### BACKGROUND

The subject of this patent application relates generally to implement supports, and more particularly, to implement supports for implements that are reversibly switchable from a held-held configuration of an implement to a surface-supported configuration of an implement.

By way of background, it is often a desire to switch between a hand-held implement which generally provides greater flexibility of use and a surface-supported implement which enables hands-free use. For example, when using a mirror, a user may choose to use a hand-held mirror which provides increased ability to finely adjust the angle of the mirror and achieve a greater array of viewing angles desired by the user. Alternatively, a user may desire to use a mirror that can be placed on a table or counter thereby freeing up both hands of the user to perform a task while looking at the mirror. However, having multiple mirrors can create clutter and diminish the useable space of a table or counter which can lead to frustration by the user.

As such, what is needed is an implement support that quickly and easily transitions from hand-held configuration to a surface-supported configuration. This implement support should be seamlessly integrated with a handle of an implement for provide a comfortable grasp and ease of use when the implement is hand-held by a user. In addition, the implement support should provide a stable and arrangeable support to a proper viewing angle when the implement is placed on a surface support and the user is using the implement in a hands-free manner.

Aspects of the present invention fulfill these needs and provide further related advantages as described in the following summary.

### BRIEF DESCRIPTION OF THE DRAWINGS

The accompanying drawings, which are incorporated in and constitute a part of this specification, illustrate aspects of the disclosed subject matter in at least one of its exemplary embodiments, which are further defined in detail in the following description. Features, elements, and aspects of the disclosure are referenced by numerals with like numerals in different drawings representing the same, equivalent, or similar features, elements, or aspects, in accordance with one or more embodiments. The drawings are not necessarily to scale, emphasis instead being placed upon illustrating the principles herein described and provided by exemplary embodiments of the invention. In such drawings:

FIG. 1 is a top, front, right, perspective view of an implement support assembly disclosed herein, shown in the hand-held configuration;

FIG. 2 is a bottom, back, left, perspective view of the implement support assembly of FIG. 1;

FIG. 3 is top, front, right, perspective view of an implement support assembly disclosed herein, shown partially disassembled;

FIG. 4 is a top, front, right, perspective view of an implement support assembly disclosed herein, shown in the surface-supported configuration;

FIG. 5 is a partial cross-sectional front view of the implement support assembly of FIG. 1, taken at 5-5;

FIG. 6 is a right side plan view of an implement support assembly disclosed herein, shown in the surface-supported configuration and arranged in a first position;

FIG. 7 is a right side plan view of an implement support assembly disclosed herein, shown in the surface-supported configuration and arranged in a second position;

FIG. 8 is a right side plan view of an implement support assembly disclosed herein, shown in the surface-supported configuration and arranged in a third position;

FIG. 9 is a front plan view of the implement support assembly of FIG. 1;

FIG. 10 is a back plan view of the implement support assembly of FIG. 1;

FIG. 11 is a left side plan view of the implement support assembly of FIG. 1;

FIG. 12 is a right side view of the implement support assembly of FIG. 1;

FIG. 13 is a top view of the implement support assembly of FIG. 1; and

FIG. 14 is a bottom view of the implement support assembly of FIG. 1.

Listing of Reference Numbers Associated with Drawings

| Ref. No. | Element |
|---|---|
| 10 | Implement support assembly |
| 20 | Hand-held mirror |
| 22 | Frame portion |
| 24 | Bezel |
| 26 | First side surface |
| 27 | Second side surface |
| 28, 28′ | Mirror |
| 30 | Handle component |
| 31 | First side |
| 32 | Second side |
| 33 | Third side |
| 34 | Proximal end |
| 35 | Distal end |
| 36 | First surface |
| 37 | Second surface |
| 38 | Edge portion |
| 39 | Center portion |
| 41 | First notch |
| 42 | Second notch |
| 42 | Third notch |
| 44 | Fourth notch |
| 45 | Fifth notch |
| 46 | Sixth notch |
| 50 | Implement support component |
| 52 | Outer surface |
| 54 | Inner surface |
| 56 | First side surface |
| 57 | Second side surface |
| 60 | Base portion |
| 62 | Handle opening |
| 64 | Center opening |
| 66 | First edge opening |
| 68 | Second edge opening |
| 70 | First prong |
| 72 | First end portion |
| 74 | Second prong |
| 78 | Second end portion |
| 80 | Groove |
| 81 | First protrusion |
| 82 | Second protrusion |
| 90 | Longitudinal axis of handle component |
| 92 | Longitudinal axis of implement support component |

### DETAILED DESCRIPTION

The present application discloses an implement system comprising an implement and implement support. An implement support assembly disclosed herein advantageously permits a user to quickly and easily transition an implement from hand-held configuration to surface-supported configuration by a simple disassembly and reassembly of a disclosed implement support disclosed herein. Thus, a user has a choice to hold an implement by hand or rearrange implement support into a stand for resting on a support surface, such as a table, counter, vanity top, etc. The present design is rugged and can be injection molded using thermoplastics or the like. Although the illustrated example is a hand-held mirror, other types of implements are compatible with an implement support disclosed herein, such as a mount for a camera, a microphone, a light, and so on.

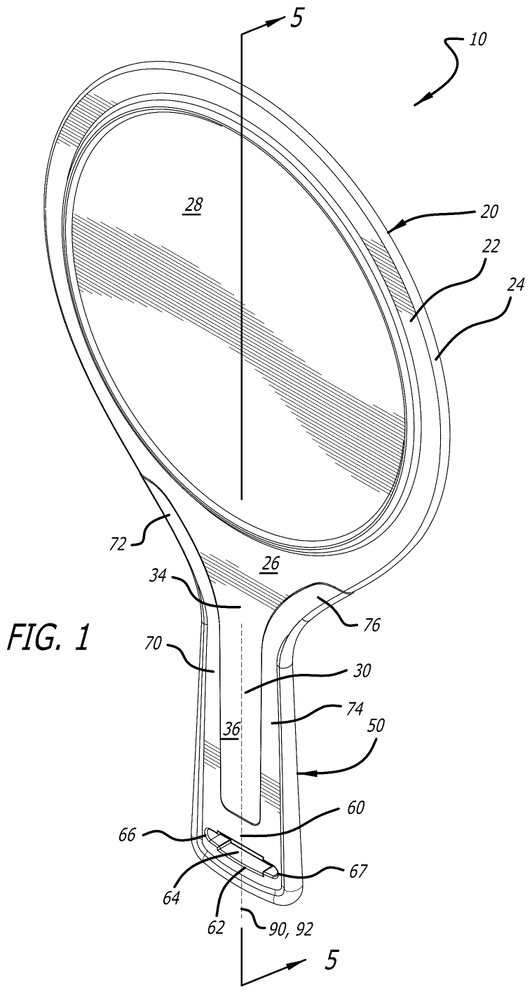

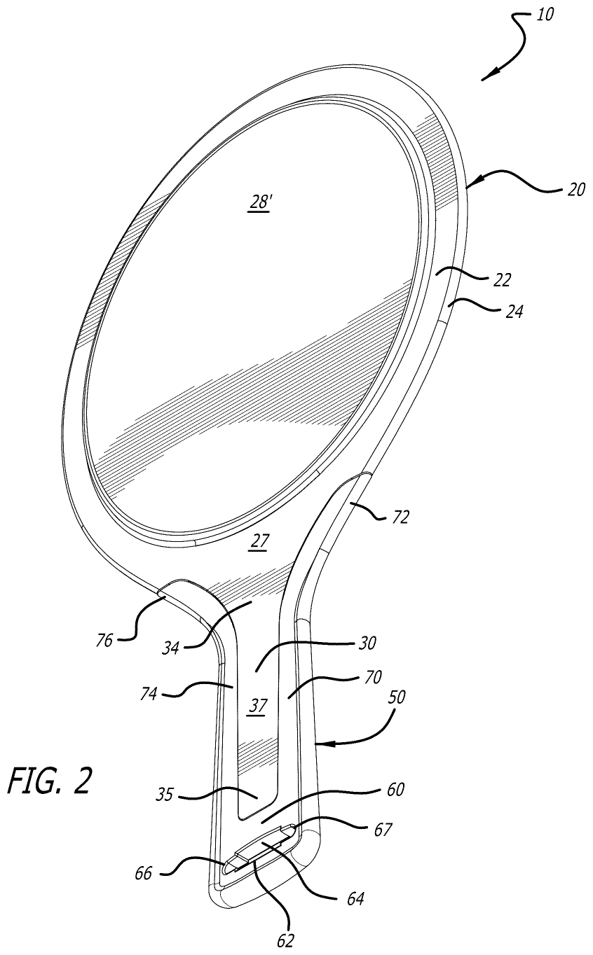

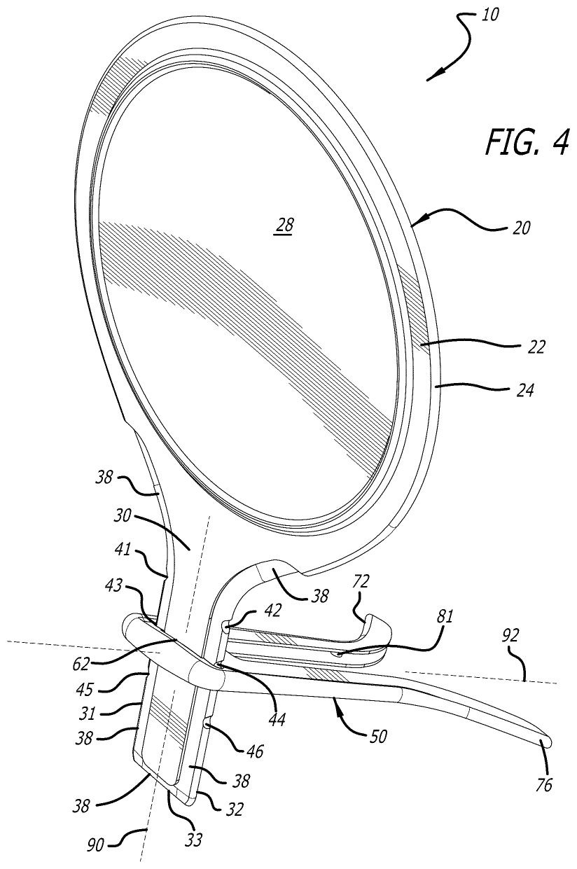

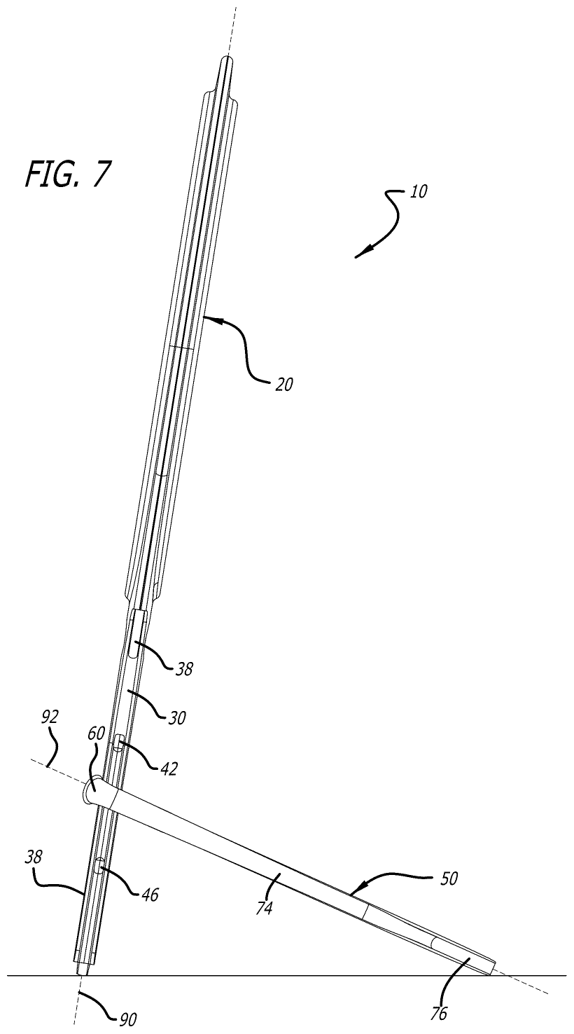

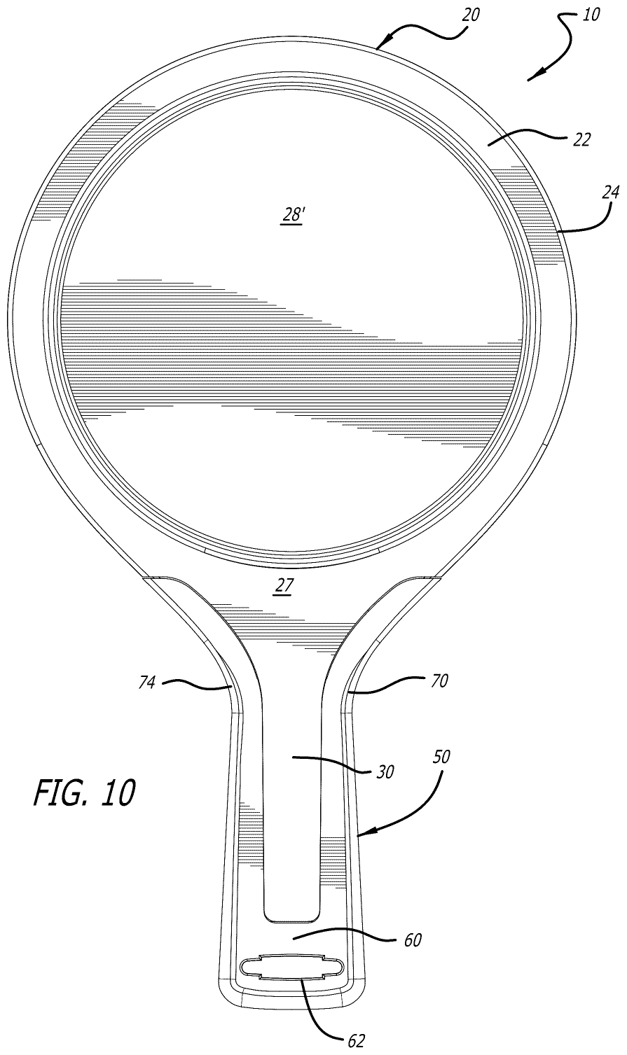

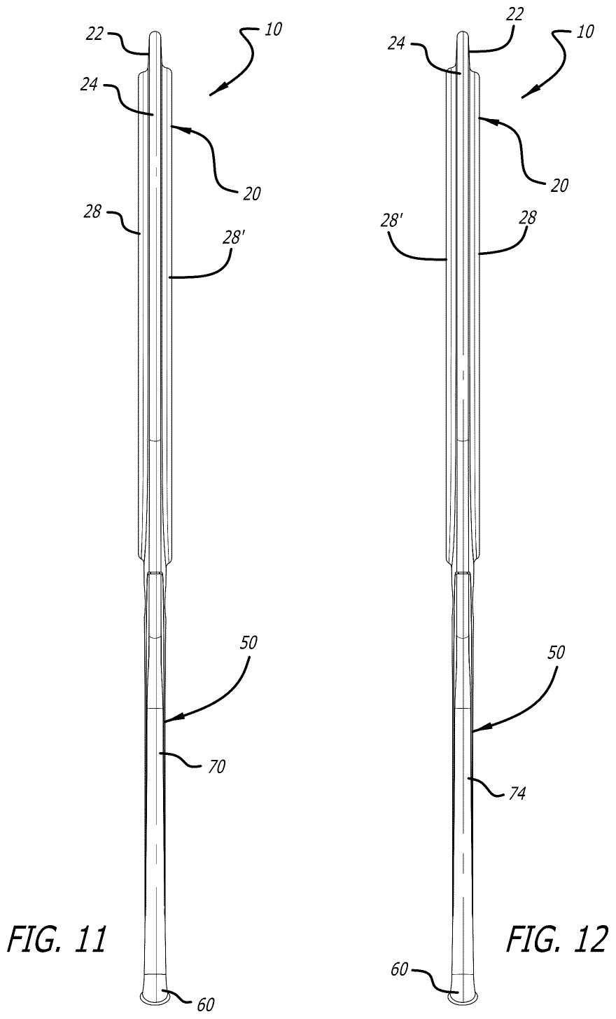

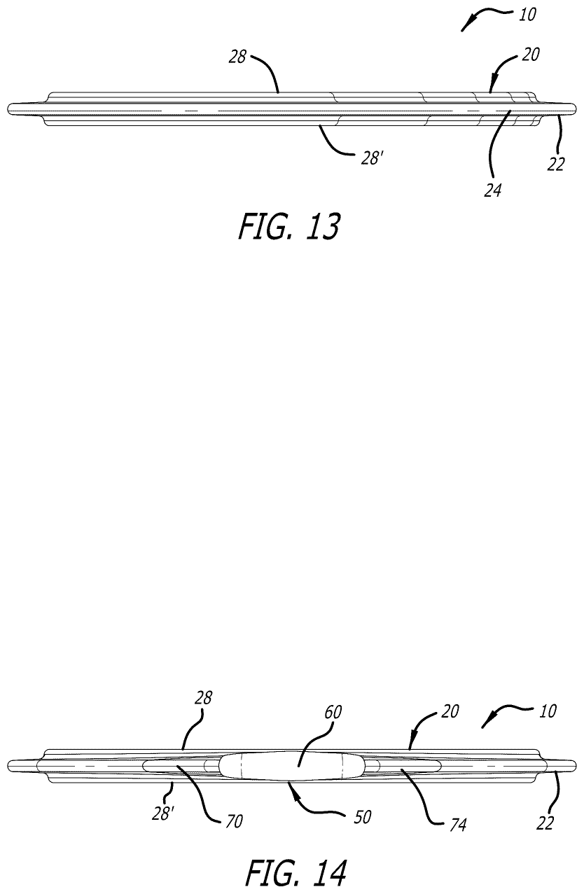

In an exemplary embodiment, and as shown in FIGS. 1-14, an implement support assembly 10 comprises a hand-held mirror 20 including a frame component 22, a mirror 28 and a handle component 30, and an implement support component 50. Handle component 30 has a longitudinal axis 90 (also referred to as handle component longitudinal axis) whereas implement support component 50 has a longitudinal axis 92 (also referred to as implement support component longitudinal axis) As best seen in FIGS. 1, 2, & 9-12, implement support assembly 10 is illustrated in the hand-held configuration where implement support component 50 is sheathed over handle component 30 of hand-held mirror 20 to provide an easy-to-hold handle. This hand-held configuration is typically employed when a user desires to manually grasp handle component 30 when using hand-held mirror 20. As best seen in FIGS. 4 & 6-8, implement support assembly 10 is illustrated in the surface-supported configuration where handle component 30 of hand-held mirror 20 is inserted through a handle opening 72 of implement support component 50 to form a stand. Further, implement support component 50 is angle and height adjustable when configured in surface-supported configuration to provide a stable, adjustable implement platform. This surface-supported configuration is typically employed when a user desires to position hand-held mirror 20 onto a support surface to enable hands-free use of hand-held mirror 20. Thus, a user has a choice to manually hold hand-held mirror 20 by integrating implement support component 50 with handle component 30 or rearranging implement support component 50 into a tripod with handle component 30 for resting on a support surface.

In some embodiments, and referring now to FIGS. 1 & 2, handle component 30 of hand-held mirror 20 is an elongated, flat peninsular structure having a first side 31, a second side 32, and a third side 33 and a proximal end 34 extending from frame component 22 and terminating in a distal end 35 as well as a first surface 36 and a second surface 37. In some embodiments, first surface 36 and second surface 37 of first side 31, second side 32, and third side 33 converge together to create a sloping region on each side of handle component 30 to form an edge portion 38 of lesser thickness than the center portion 39 of handle component 30. Edge portion 38 is configured to be slidably received within a groove of implement support component 50, much like the tongue of a tongue and groove joint. Thus, when implement support component 50 sheaths handle component 30 with edge portion 38 positioned within a groove of implement support component 50, the transition between handle component 30 and implement support component 50 is level and substantially without a step.

In some embodiments, and referring to FIGS. 4-8, along the length of handle component 30 at discrete points are one or more notches formed into edge portion 38 of first side 31 or second side 32, and as shown by first notch 41, second notch 42, third notch 43, fourth notch 44, fifth notch 45, and sixth notch 46. Each of the one or more notches are configured to receive a protrusion located on an inner surface of implement support component 50. In some embodiments, the disclosed notches are paired with one notch located on first side 31 and another notch located on second side 32 of handle component 30 directly opposite the first notch. For example, and as shown in FIGS. 4-8, first notch 41 is formed into edge portion 38 of first side 31 and is paired with second notch 42 formed into edge portion 38 second side 32, directly opposite first notch 41; third notch 43 is formed into edge portion 38 of first side 31 and is paired with fourth notch 44 formed into edge portion 38 second side 32, directly opposite third notch 43; and fifth notch 45 is formed into edge portion 38 of first side 31 and is paired with sixth notch 46 formed into edge portion 38 second side 32, directly opposite fifth notch 45.

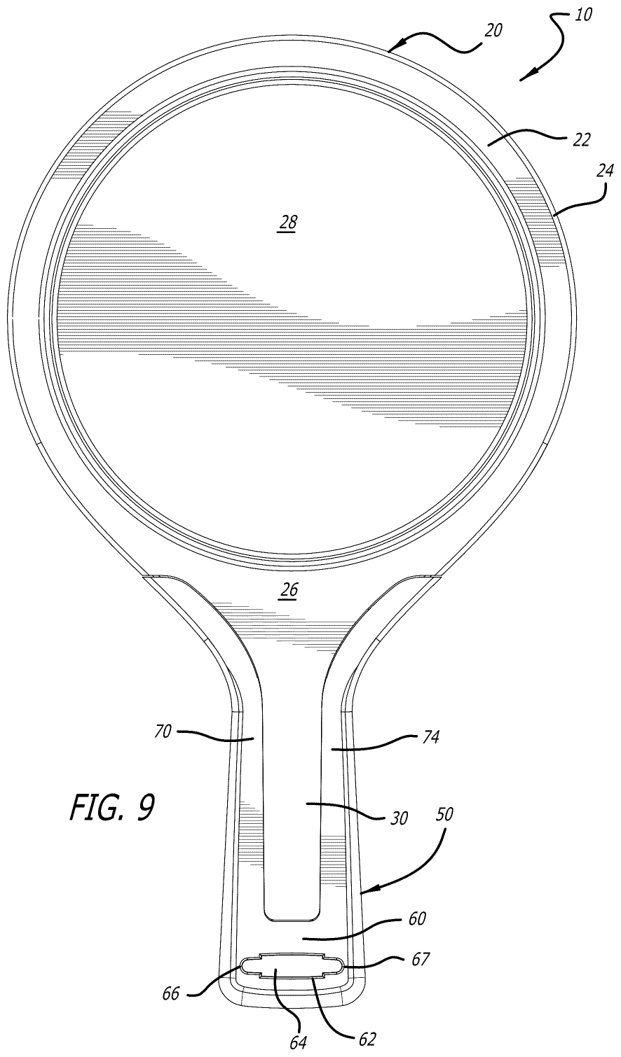

In some embodiments, frame component 22 of hand-held mirror 20 is a flat disk-like support structure used for mounting or otherwise securing thereto mirror 28. Frame component 22 can be configured to mount or otherwise secure mirror 28 on a first surface 26, or a second surface 27, or both first and second surfaces 26, 27 of frame component 22. Additionally, mirror 28 can provide a reflective surface having a zero magnification property of a reflected image, as depicted by a mirror 28 in FIGS. 1-4 & 9 or can provide a reflective surface having a magnification property that increases the size of a reflected image, as depicted by a mirror 28′ in FIG. 10. In some embodiments, frame component 22 can also include an integrally molded bezel 24 or other type of border to protect mirror 28 from chipping and other breakage.

In some embodiments, handle component 30 is integrally molded with frame component 22 of hand-held mirror 20. In some embodiments, handle component 30 is reversibly detachable with frame component 22 of hand-held mirror 20.

In some embodiments and referring to FIGS. 1-5 implement support component 50 is a U-shaped structure having a base portion 60 from which perpendicularly extends a first prong 70 having a first end portion 72 from one end of base portion 60 and a second prong 74 having second end portion 76 from the opposite end of base portion 60. First and second prongs 70, 74 extend substantially parallel to each other but can then optionally diverge towards their distal ends where first and second end portions 72, 76 flare outwardly or otherwise angled away from one another. The divergence of first and second end portions 72, 76 are shaped to follow the contour of frame component 22 and permit first and second prongs 70, 74 to smoothly align with and integrate into frame component 22 (which is circular here) when in the hand-held configuration as well as to provide additional stability when implement support component 50 is in the surface-supported configuration.

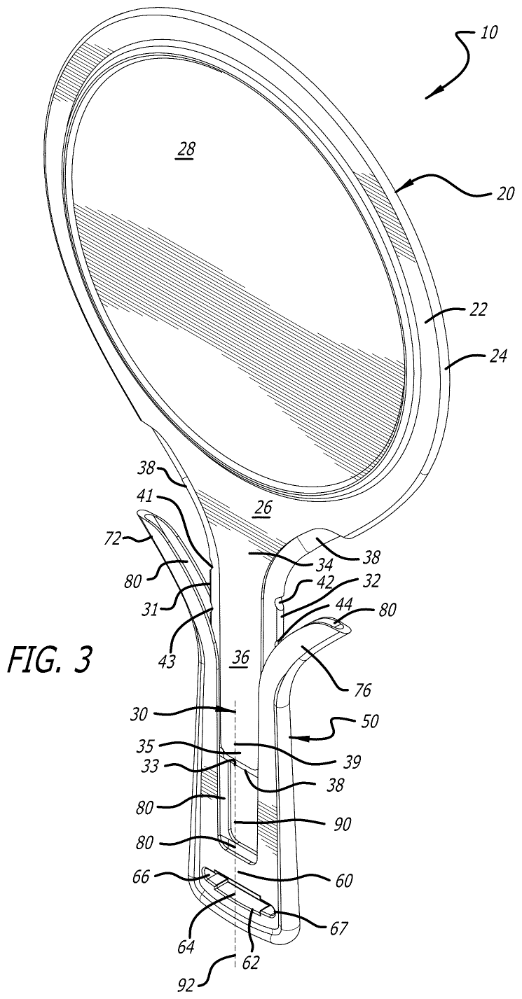

As best seen in FIGS. 3 & 4, implement support component 50 comprises an outer surface 52 and an inner surface 54 as well as a first side surface 56 and a second side surface 57. A groove 80 is defined by the inner surfaces of outer surface 52, first side surface 56 and second side surface 57. Groove 80 runs the entire length of implement support component 50 from first end portion 72 of first prong 70 across to second end portion 76 of second prong 74 and base portion 60 therebetween. Groove 80 is configured to receive edge portion 38 of first, second, and third sides 31, 32, 33 of handle component 30 much like the tongue of a tongue and groove joint. In alternative embodiments, a groove can be formed in handle component 30 and an edge portion can be formed on implement support component 50 in order to create a tongue and groove joint, depending on manufacturing, design, and usage requirements.

In some embodiments, within groove 80 of implement support component 50 along first prong 70 is a first protrusion 81 and along second prong 74 is a second protrusion 82 opposite first protrusion 81. First and second protrusions 81, 82 are configured to reversibly snap fit into one or more notches disclosed herein of edge portion 38 of first and second sides 31, 32 of handle component 30, as will be described below. In some embodiments, first and second protrusions 81, 82 have a rounded profile or are otherwise provided with a lead angle and a returning angle.

Implement support component 50 is composed of a flexible and durable material like plastic, thermoplastics or the like and molded as a separate component that is selectively attachable to handle component 30 of hand-held mirror 20.

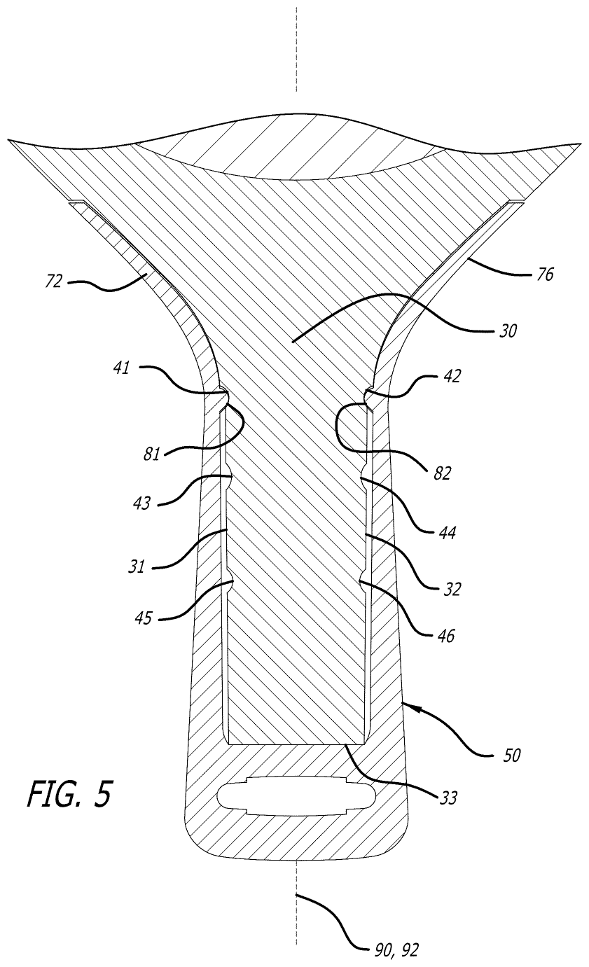

Referring to FIGS. 1-3 & 5, implement support component 50 also comprises handle opening 62, a hole formed through base portion 60 of implement support component 50. Handle opening 62 is generally shaped to receive therethrough or therein handle component 30. In some embodiments, handle opening 62 can optionally include features that releasably catch or frictionally engage discrete portions (or optionally, at any portion) of handle component 30 along its length when in the surface-supported configuration. In addition, handle opening 62 is shaped to closely match the cross-sectional profile of handle component 30, with clearance to permit sliding of handle component 30 within handle opening 62. For example, and as best seen in FIGS. 5, 9 & 10, handle opening 62 includes a rectangular, enlarged center opening 64 configured to receive handle component 30, with a first and second rounded profile edge openings 66, 68 extending from each short side of enlarged center opening 64 and configured to receive edge portion 38 of first and second sides 31, 32 of handle component 30.

To configure hand-held mirror 20 into the hand-held configuration, and now referring to FIGS. 1, 3, & 5, a user can first align edge portion 38 of first side 31 with groove 80 of first prong 70 at first end portion 72 and align edge portion 38 of second side 32 with groove 80 of second prong 74 near second end portion 76. When present, the outward flaring of first and second end portions 72, 76 can facilitate this alignment. Once aligned, a user can then slide implement support component 50 over handle component 30 using grooves 80 of first and second prongs 70, 74 as guides until third side 33 of handle component 30 inserts into and/or abuts groove 80 of base connector 60 of implement support component 50. In addition, when fully inserted, first notch 41 of handle component 30 is caught within first protrusion 81 of implement support component 50 and second notch 42 of handle component 30 is caught within second protrusion 82 of implement support component 50 to form a separable snap fit joint that prevents inadvertent sliding and separation of implement support component 50 from handle component 30. As shown in FIG. 1, in the hand-held configuration, implement support component 50 is connected to handle component 30 with implement support component longitudinal axis 92 oriented substantially parallel with handle component longitudinal axis 90. The hand-held configuration creates an easy-to-hold handle that is typically employed when a user desires to manually grasp and manipulate hand-held mirror 20 during use.

Additionally, looking at FIGS. 3 & 5, since implement support component 50 is made of a flexible material, first and second prongs 70, 74 can outwardly flex to permit first and second protrusions 81, 82 to be transition into and out of first and second notches 41, 42 as well as third and fourth notches 43, 44 or fifth and sixth notches 45, 46, respectively. For example, as a user pulls or pushes on implement support component 50 relative to handle component 30, first and second protrusions 81, 82 smoothly ride on edge portion 38 with flexure of first and second prongs 70, 74 providing an inward bias force to permit first and second protrusions 81, 82 to snap into first and second notches 41, 42, third and fourth notches 43, 44 or fifth and sixth notches 45, 46. In this way, implement support component 50 is firmly held to handle component 30, yet easily separated for transitioning between the hand-held configuration and the surface-supported configurations. In addition, this design enables implement support component 50 to be firmly held in place when handle component 30 is only partially sheathed, thereby employing implement support component 50 as a means to lengthen handle component 30. For example, and as best seen in FIG. 3, first and second protrusions 81, 82 can be repositioned to catch third and fourth notches 43, 44, respectively or repositioned to catch fifth and sixth notches 45, 46, respectively, to lengthen handle component 30.

To configure hand-held mirror 20 into the surface-supported configuration, and now referring to FIGS. 4, & 6-8, a user can align distal end 35 of handle component 30 with handle opening 62 of implement support component 50 so that edge portion 38 of first side 31 aligns with first edge opening 66 of handle opening 62 and edge portion 38 of second side 32 aligns with second edge opening 68 of handle opening 62. Once aligned, a user can then insert handle component 30 through handle opening 62. In some embodiments, implement support component 50 is frictionally held in a desired position and thus can be slid to any position along handle component 30 due to the normal force provided by torque between handle component 30 and implement support component 50. However, in other embodiments, first and second edge openings 66, 68 of handle opening 60 can be caught by and snaped into first and second notches 41, 42, third and fourth notches 43, 44 or fifth and sixth notches 45, 46, thereby providing mechanical interference to sliding between handle component 30 and implement support component 50 that enables a more stable arrangement. Once handle component 30 is positioned within handle opening 62 of implement support component 50 at its desired location, the surface-supported configuration provides a stable tripod arrangement, where distal end 35 of handle component 30, first end portion 72 of first prong 70, and second end portion 76 of second prong 74 contact a support surface in a large, stable footprint. Additionally, this stable tripod arrangement can be enhanced in embodiments where first end portion 72 of first prong 70 is flared outwardly and second end portion 76 of second prong 74 is oppositely flared outwardly. As shown in FIG. 4, in the surface-supported configuration, implement support component 50 is connected to handle component 30 with implement support component longitudinal axis 92 oriented transversely to handle component longitudinal axis 90. The surface-supported configuration creates a stable and adjustable platform that is typically employed when a user desires to place hand-held mirror 20 onto a support surface to enable hands-free use of hand-held mirror 20.

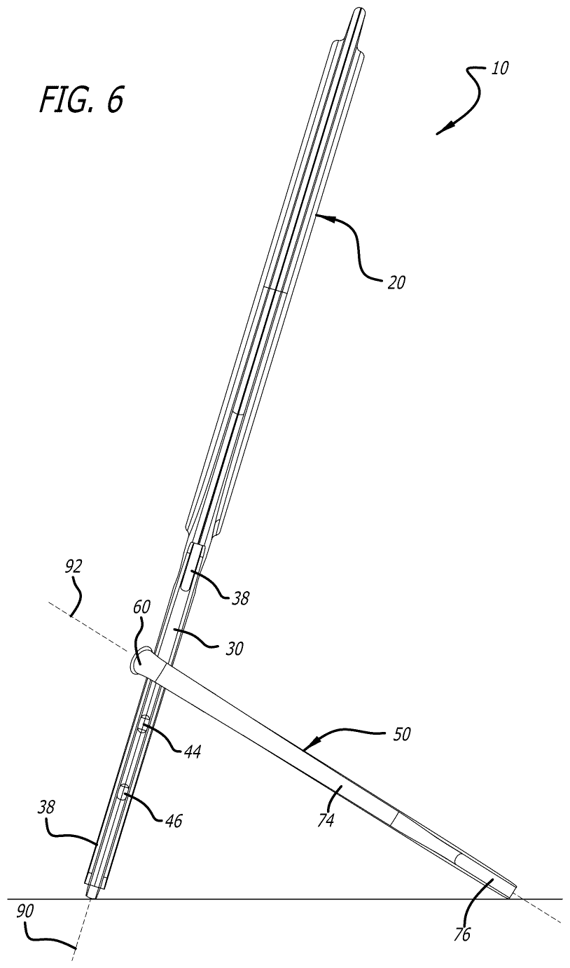

Looking also at FIGS. 6-8, the height and angle of hand-held mirror 20 relative to a support surface can be adjusted by sliding implement support component 50 up or down the length of handle component 30 which will change the angle of handle component 30 along its longitudinal axis 90. Additionally, changing the angle of handle component 30 along its longitudinal axis 90 will also change the height of hand-held mirror 20 relative to the support surface. If hand-held mirror 20 is angle adjustable (i.e., hinged, on a gimbal, etc.), then the angle of hand-held mirror 20 relative to the support surface can be maintained and/or can be changed to a desired angle.

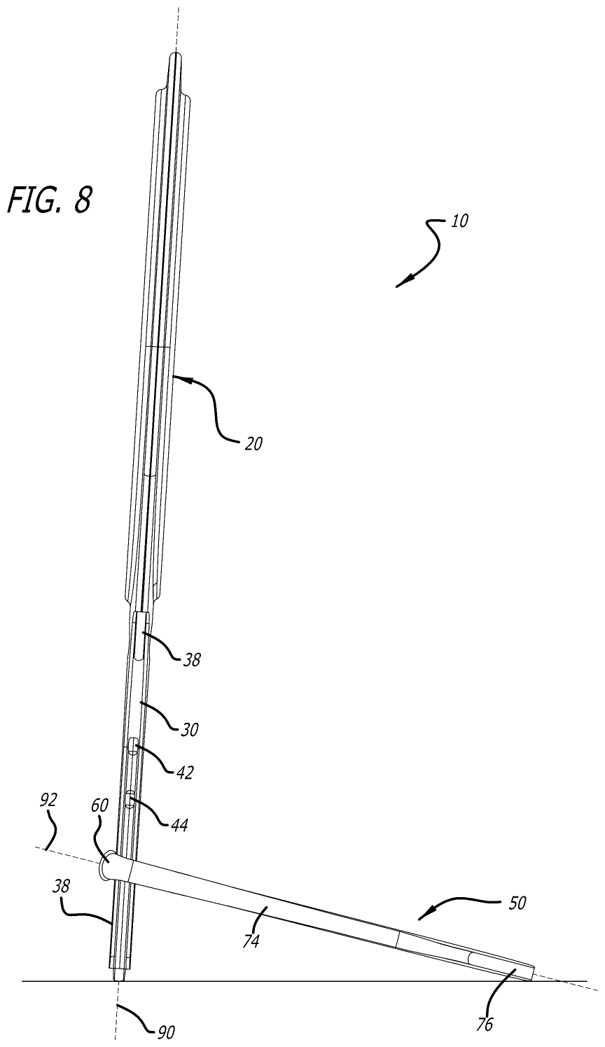

For example, to position hand-held mirror 20 in at a lower angle relative to the support surface (i.e., much less than 90 degrees to the support surface, such as, e.g., an angle between 45 degrees to 70 degrees to the support surface), a first position or orientation can be adopted where handle opening 62 is positioned around proximal end 34 of handle component 30 near frame portion 22 (as illustrated in FIG. 6). In embodiments where handle component 30 comprises notches, first and second edge openings 66, 68 of handle opening 62 can be caught by and snapped into first and second notches 41, 42 of handle component 30. To position hand-held mirror 20 in a middle or intermediate angle relative to the support surface (such as, e.g., an angle between 70 degrees to 80 degrees to the support surface) in a second position or orientation can be adopted where handle opening 62 is centrally positioned lengthwise on handle component 30 (as illustrated in FIGS. 4 & 7). In embodiments where handle component 30 comprises notches, first and second edge openings 66, 68 of handle opening 62 can be caught by and snaped into third and fourth notches 43, 44 of handle component 30. To position hand-held mirror 20 in a more upright position (i.e., closer to 90 degrees to the support surface, such as, e.g., an angle between 80 degrees to 90 degrees to the support surface) in a third position or orientation can be adopted where handle opening 62 is positioned around distal end 35 of handle component 30 (as illustrated in FIG. 8). In embodiments where handle component 30 comprises notches, first and second edge openings 66, 68 of handle opening 62 can be caught by and snaped into fifth and sixth notches 45, 46 of handle component 30.

Aspects of the present specification may also be described by the following embodiments:
1. A handled implement support assembly comprising: a handled implement including a handle component, the handle component having a length with a proximal end and a distal end opposite the proximal end, and a handle component longitudinal axis; and an implement support component including a handle opening and having an implement support component longitudinal axis, the implement support component being detachably connected to the handle component; wherein, when assembled in a hand-held configuration, the implement support component is connected to the handle component with the implement support component longitudinal axis oriented substantially parallel with the handle component longitudinal axis; and wherein, when assembled in a surface-supported configuration, the handle component is inserted into the handle opening of the implement support component with the implement support component longitudinal axis oriented transversely to the handle component longitudinal axis, such that the implement support component and the handle component form a stand that supports the handled implement on a surface.
2. The handled implement support assembly of embodiment 1 wherein, when assembled in a hand-held configuration, the handle component fits into the implement support component.
3. The handled implement support assembly of embodiment 1 or 2, wherein the implement support component is a U-shaped structure comprising a base portion, a first prong, and a second prong, the first prong spaced apart from the second prong by the base portion, with the first and second prongs each perpendicularly extending from the base portion,
4. The handled implement support assembly of embodiment 3 wherein a groove is formed on an inner surface of the first prong, the base portion, and the second prong, the groove slidably receiving therein an edge portion of the handle component when assembled in hand-held configuration.
5. The handled implement support assembly of any one of embodiments 1-4, further comprising a snap fit joint configured to releasably hold the implement support component to the handle component when assembled in hand-held configuration.
6. The handled implement support assembly of embodiment 5, wherein the snap fit joint comprises a first protrusion located on the first prong within the groove opposing a second protrusion located on the second prong within the groove and a first notch located on the edge portion of the handle component opposing a second notch located on the edge portion of the handle component, the first protrusion being positioned within the first notch and the second protrusion being positioned within the second notch.
6. The handled implement support assembly of embodiment 4, wherein the edge portion of the handle component includes a first notch opposing a second notch, and when assembled in hand-held configuration, a first protrusion located on the first prong within the groove releasably engages with the first notch to form a first snap fit joint and a second protrusion located on the second prong within the groove releasably engages with the second notch to form a first snap fit joint, thereby securing the implement support component to the handle component, and when assembled in surface-supported configuration, the handle opening releasably engages with the first notch and the second notch when the handle component is inserted within the handle opening to hold the handled implement in a first position.
7. The handled implement support assembly of any one of embodiments 3-6, wherein a first end portion of the first prong is arranged distally from the base portion and a second end portion of the second prong is arranged distally from the base portion.
8. The handled implement support assembly of embodiment 7, wherein, when assembled in the surface-supported configuration, the distal end of the handle component, the first end portion of the first prong, and the second end portion of the second prong all contact a support surface to form a tripod.
9. The handled implement support assembly of embodiment 8, wherein the edge portion of the handle component further includes a third notch opposing a fourth notch, when assembled in hand-held configuration, a first protrusion located on the first prong within the groove releasably engages with the third notch to form a third snap fit joint and a second protrusion located on the second prong within the groove releasably engages with the fourth notch to form a fourth snap fit joint, thereby securing the implement support component to the handle component and extending the length of the handle component, and when assembled in surface-supported configuration, the handle opening releasably engages with the third notch and the fourth notch when the handle component is inserted within the handle opening to hold the handled implement in a second position.
10. The handled implement support assembly of embodiment 9, wherein the edge portion of the handle component further includes a fifth notch opposing a sixth notch, when assembled in hand-held configuration, a first protrusion located on the first prong within the groove releasably engages with the fifth notch to form a fifth snap fit joint and a second protrusion located on the second prong within the groove releasably engages with the sixth notch to form a sixth snap fit joint, thereby securing the implement support component to the handle component and extending the length of the handle component, and when assembled in surface-supported configuration, the handle opening releasably engages with the fifth notch and the sixth notch when the handle component is inserted within the handle opening to hold the handled implement in a third position.
11. The handled implement support assembly of embodiment 4, wherein the edge portion of the handle component includes a first notch opposing a second notch and a third notch opposing a fourth notch, wherein, when assembled in the surface-supported configuration, the handle component is inserted within the handle opening of the implement support component, and the handle opening engaging with the first notch and the second notch to hold the implement in a first position and the handle component is inserted within the handle opening of the implement support component and the handle opening engaging with the third notch and the fourth notch to hold the handled implement portion in a second position.
12. A hand-held mirror support assembly comprising: a hand-held mirror comprising a handle component, a frame component and a mirror, the handle component having a length with a proximal end and a distal end opposite the proximal end, and an edge portion, and having a handle component longitudinal axis; the frame component located at the proximal end of the handle component and the mirror being supported by the frame component; and an implement support having an implement support component longitudinal axis, the implement support component configured as a U-shaped structure comprising a base portion including a handle opening, a first prong, and a second prong, the first prong spaced apart from the second prong by the base portion, with the first and second prongs each perpendicularly extending from the base portion, wherein a groove is formed on an inner surface of the first prong, the base portion, and the second prong, the groove configured to slidably receive therein the edge portion of the handle component when assembled in hand-held configuration, wherein the implement support component is detachably connected to the handle component; wherein, when assembled in a hand-held configuration, the implement support component is connected to the handle component with the edge portion of handle component fitted at least partially within the groove and the implement support component longitudinal axis oriented substantially parallel with the handle component longitudinal axis; and wherein, when assembled in a surface-supported configuration, the handle component is inserted into the handle opening of the implement support component with the implement support component longitudinal axis oriented transversely to the handle component longitudinal axis, such that the implement support component and the handle component form a stand that supports the hand-held mirror on a surface.
13. The hand-held mirror support assembly of embodiment 12 further comprising a snap fit joint configured to releasably hold the implement support component to the handle component when assembled in hand-held configuration.
14. The hand-held mirror support assembly of embodiment 13, wherein the snap fit joint comprises a first protrusion located on the first prong within the groove opposing a second protrusion located on the second prong within the groove and a first notch located on the edge portion of the handle component opposing a second notch located on the edge portion of the handle component, the first protrusion being positioned within the first notch and the second protrusion being positioned within the second notch.
15. The hand-held mirror support assembly of any one of embodiments 10-14, wherein the edge portion of the handle component includes a first notch opposing a second notch, and when assembled in hand-held configuration, a first protrusion located on the first prong within the groove releasably engages with the first notch to form a first snap fit joint and a second protrusion located on the second prong within the groove releasably engages with the second notch to form a first snap fit joint, thereby securing the implement support component to the handle component, and when assembled in surface-supported configuration, the handle opening releasably engages with the first notch and the second notch when the handle component is inserted within the handle opening to hold the hand-held mirror in a first position.
16. The hand-held mirror support assembly of embodiment 15, wherein the edge portion of the handle component further includes a third notch opposing a fourth notch, when assembled in hand-held configuration, a first protrusion located on the first prong within the groove releasably engages with the third notch to form a third snap fit joint and a second protrusion located on the second prong within the groove releasably engages with the fourth notch to form a fourth snap fit joint, thereby securing the implement support component to the handle component and extending the length of the handle component, and when assembled in surface-supported configuration, the handle opening releasably engages with the third notch and the fourth notch when the handle component is inserted within the handle opening to hold the hand-held mirror in a second position.
17. The hand-held mirror support assembly of embodiment 16, wherein the edge portion of the handle component further includes a fifth notch opposing a sixth notch, when assembled in hand-held configuration, a first protrusion located on the first prong within the groove releasably engages with the fifth notch to form a fifth snap fit joint and a second protrusion located on the second prong within the groove releasably engages with the sixth notch to form a sixth snap fit joint, thereby securing the implement support component to the handle component and extending the length of the handle component, and when assembled in surface-supported configuration, the handle opening releasably engages with the fifth notch and the sixth notch when the handle component is inserted within the handle opening to hold the hand-held mirror in a third position.
18. The hand-held mirror support assembly of any one of embodiments 12-14, wherein the edge portion of the handle component includes a first notch opposing a second notch and a third notch opposing a fourth notch, wherein, when assembled in the surface-supported configuration, the handle component is inserted within the handle opening of the implement support component, and the handle opening engaging with the first notch and the second notch to hold the hand-held mirror in a first position or the handle component is inserted within the handle opening of the implement support component and the handle opening engaging with the third notch and the fourth notch to hold the hand-held mirror portion in a second position.
19. The hand-held mirror support assembly of any one of embodiments 10-18, wherein a first end portion of the first prong is arranged distally from the base portion and a second end portion of the second prong is arranged distally from the base portion.
20. The hand-held mirror support assembly of embodiment 19, wherein the first end portion and the second end portion diverge from one another.
21. The hand-held mirror support assembly of any one of embodiments 10-20, wherein, when assembled in the surface-supported configuration, the distal end of the handle component, the first end portion of the first prong, and the second end portion of the second prong all contact a support surface to form a tripod.
22. A method of assembling a handled implement support assembly in a surface-supported configuration, the method comprising: providing a handled implement support assembly comprising: a handled implement including a handle component, the handle component having a length with a proximal end and a distal end opposite the proximal end, and a handle component longitudinal axis; and an implement support component including a handle opening and having an implement support component longitudinal axis, detaching the implement support component from the handle component to transition away from a hand-held configuration where the implement support component longitudinal axis is oriented substantially parallel with the handle component longitudinal axis; inserting the handle component into the handle opening of the implement support component to transition into a surface-supported configuration where the implement support component longitudinal axis is oriented transversely to the handle component longitudinal axis, such that the implement support component and the handle component form a stand that supports the handled implement on a surface.
23. A method of assembling a handled implement support assembly in a surface-supported configuration, the method comprising: providing a handled implement support assembly as defined in embodiments 1-11: inserting the handle component into the handle opening of the implement support component to transition into a surface-supported configuration where the implement support component longitudinal axis is oriented transversely to the handle component longitudinal axis, such that the implement support component and the handle component form a stand that supports the handled implement on a surface.
24. The method of embodiment 23, further comprising detaching the implement support component from the handle component to transition away from a hand-held configuration where the implement support component longitudinal axis is oriented substantially parallel with the handle component longitudinal axis.
25. A method of assembling a hand-held mirror support assembly in a surface-supported configuration, the method comprising: providing a hand-held mirror support assembly comprising: a handled implement including a handle component, the handle component having a length with a proximal end and a distal end opposite the proximal end, and a handle component longitudinal axis; and an implement support component including a handle opening and having an implement support component longitudinal axis, detaching the implement support component from the handle component to transition away from a hand-held configuration where the implement support component longitudinal axis is oriented substantially parallel with the handle component longitudinal axis; inserting the handle component into the handle opening of the implement support component to transition into a surface-supported configuration where the implement support component longitudinal axis is oriented transversely to the handle component longitudinal axis, such that the implement support component and the handle component form a stand that supports the hand-held mirror on a surface.
26. A method of assembling a hand-held mirror support assembly in a surface-supported configuration, the method comprising: providing a hand-held mirror support assembly as defined in embodiments 12-21: inserting the handle component into the handle opening of the implement support component to transition into a surface-supported configuration where the implement support component longitudinal axis is oriented transversely to the handle component longitudinal axis, such that the implement support component and the handle component form a stand that supports the hand-held mirror on a surface.
27. The method of embodiment 26, further comprising detaching the implement support component from the handle component to transition away from a hand-held configuration where the implement support component longitudinal axis is oriented substantially parallel with the handle component longitudinal axis.
28. The method of embodiment 26 or 27, wherein the edge portion of the handle component includes a first notch opposing a second notch, and the handle opening releasably engages with the first notch and the second notch when the handle component is inserted within the handle opening to hold the hand-held mirror in a first position.
29. The method of embodiment 28, wherein the edge portion of the handle component further includes a third notch opposing a fourth notch, and the handle opening releasably engages with the third notch and the fourth notch when the handle component is inserted within the handle opening to hold the hand-held mirror in a second position.
30. The method of embodiment 29, wherein the edge portion of the handle component further includes a fifth notch opposing a sixth notch, and the handle opening releasably engages with the fifth notch and the sixth notch when the handle component is inserted within the handle opening to hold the hand-held mirror in a third position.

In closing, foregoing descriptions of embodiments of the present invention have been presented for the purposes of illustration and description. It is to be understood that, although aspects of the present invention are highlighted by referring to specific embodiments, one skilled in the art will readily appreciate that these described embodiments are only illustrative of the principles comprising the present invention and such examples are not limiting thereto. As such, the specific embodiments are not intended to be exhaustive or to limit the invention to the precise forms disclosed. The use of any and all examples or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

In addition, groupings of alternative embodiments, elements, steps and/or limitations of the present invention are not to be construed as limitations. Each such grouping may be referred to and claimed individually or in any combination with other groupings disclosed herein. It is anticipated that one or more alternative embodiments, elements, steps and/or limitations of a grouping may be included in, or deleted from, the grouping for reasons of convenience and/or patentability. When any such inclusion or deletion occurs, the specification is deemed to contain the grouping as modified, thus fulfilling the written description of all Markush groups used in the appended claims. In addition, all methods described herein can be performed in any suitable order unless otherwise indicated herein or otherwise clearly contradicted by context. Therefore, it should be understood that embodiments of the disclosed subject matter are in no way limited to a particular element, compound, composition, component, article, apparatus, methodology, use, protocol, step, and/or limitation described herein, unless expressly stated as such.

While aspects of the inventive subject matter have been described with reference to at least one exemplary embodiment, it is to be clearly understood by those skilled in the art that the inventive subject matter is not limited thereto. For example, although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed. Furthermore, those of ordinary skill in the art will recognize that certain changes, modifications, permutations, alterations, additions, subtractions, and sub-combinations thereof can be made in accordance with the teachings herein without departing from the spirit of the present inventive subject matter. Thus, while the inventive subject matter is susceptible of various modifications and alternative embodiments, certain illustrated embodiments thereof are shown in the drawings and will be described below in detail. It should be understood, however, that there is no intention to limit the inventive subject matter to any specific form disclosed, but on the contrary, the inventive subject matter is to cover all modifications, alternative embodiments, and equivalents falling within the scope of the claims. It is intended that the following appended claims and claims hereafter introduced are interpreted to include all such changes, modifications, permutations, alterations, additions, subtractions, and sub-combinations as are within their true spirit and scope. Accordingly, the scope of the present inventive subject matter is not to be limited to that precisely as shown and described by this specification. Rather, the scope of the inventive subject matter is to be interpreted only in conjunction with the appended claims and it is made clear, here, that the inventor(s) believe that the claimed subject matter is the inventive subject matter.

Certain embodiments of the present inventive subject matter are described herein, including the best mode known to the inventors for conducting the inventive subject matter. Of course, variations on these described embodiments will become apparent to those of ordinary skill in the art upon reading the foregoing description. The inventor expects skilled artisans to employ such variations as appropriate, and the inventors intend for the present inventive subject matter to be practiced otherwise than specifically described herein. Accordingly, this inventive subject matter includes all modifications and equivalents of the subject matter recited in the claims appended hereto as permitted by applicable law. Moreover, any combination of the above-described embodiments in all possible variations thereof is encompassed by the inventive subject matter unless otherwise indicated herein or otherwise clearly contradicted by context.

The words, language, and terminology used in this specification is for the purpose of describing particular embodiments, elements, steps and/or limitations only and is not intended to limit the scope of the present inventive subject matter, which is defined solely by the claims. In addition, such words, language, and terminology are to be understood not only in the sense of their commonly defined meanings, but to include by special definition in this specification structure, material or acts beyond the scope of the commonly defined meanings. Thus, if an element, step or limitation can be understood in the context of this specification as including more than one meaning, then its use in a claim must be understood as being generic to all possible meanings supported by the specification and by the word itself.

The definitions and meanings of the elements, steps or limitations recited in a claim set forth below are, therefore, defined in this specification to include not only the combination of elements, steps or limitations which are literally set forth, but all equivalent structure, material or acts for performing substantially the same function in substantially the same way to obtain substantially the same result. In this sense it is therefore contemplated that an equivalent substitution of two or more elements, steps and/or limitations may be made for any one of the elements, steps or limitations in a claim set forth below or that a single element, step, or limitation may be substituted for two or more elements, steps and/or limitations in such a claim. Although elements, steps or limitations may be described above as acting in certain combinations and even initially claimed as such, it is to be expressly understood that one or more elements, steps and/or limitations from a claimed combination can in some cases be excised from the combination and that the claimed combination may be directed to a sub-combination or variation of a sub-combination. As such, notwithstanding the fact that the elements, steps and/or limitations of a claim are set forth below in a certain combination, it must be expressly understood that the inventive subject matter includes other combinations of fewer, more, or different elements, steps and/or limitations, which are disclosed in above combination even when not initially claimed in such combinations. Furthermore, insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. Accordingly, the claims are thus to be understood to include what is specifically illustrated and described above, what is conceptually equivalent, what can be obviously substituted and also what essentially incorporates the essential idea of the inventive subject matter.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Similarly, as used herein, unless indicated to the contrary, the term “substantially” is a term of degree intended to indicate an approximation of the characteristic, item, quantity, parameter, property, or term so qualified, encompassing a range that can be understood and construed by those of ordinary skill in the art. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques.

Notwithstanding that the numerical ranges and values setting forth the broad scope of the inventive subject matter are approximations, the numerical ranges and values set forth in the specific examples are reported as precisely as possible. Any numerical range or value, however, inherently contains certain errors necessarily resulting from the standard deviation found in their respective testing measurements. Unless the context dictates the contrary, all ranges set forth herein should be interpreted as being inclusive of their endpoints and open-ended ranges should be interpreted to include only commercially practical values. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein. Similarly, all lists of values should be considered as inclusive of intermediate values unless the context indicates the contrary.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a comparable manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present inventive subject matter (especially in the context of the following claims) are to be construed to cover both the singular and the plural, unless otherwise indicated herein or clearly contradicted by context. Further, ordinal indicators-such as, e.g., “first,” “second,” “third,” etc.—for identified elements are used to distinguish between the elements, and do not indicate or imply a required or limited number of such elements, and do not indicate a particular position or order of such elements unless otherwise specifically stated.

When used in the claims, whether as filed or added per amendment, the open-ended transitional term “comprising”, variations thereof such as, e.g., “comprise” and “comprises”, and equivalent open-ended transitional phrases thereof like “including”, “containing” and “having”, encompass all the expressly recited elements, limitations, steps, integers, and/or features alone or in combination with unrecited subject matter; the named elements, limitations, steps, integers, and/or features are essential, but other unnamed elements, limitations, steps, integers, and/or features may be added and still form a construct within the scope of the claim. Specific embodiments disclosed herein may be further limited in the claims using the closed-ended transitional phrases “consisting of” or “consisting essentially of” (or variations thereof such as, e.g., “consist of”, “consists of”, “consist essentially of”, and “consists essentially of”) in lieu of or as an amendment for “comprising.” When used in the claims, whether as filed or added per amendment, the closed-ended transitional phrase “consisting of” excludes any element, limitation, step, integer, or feature not expressly recited in the claims. The closed-ended transitional phrase “consisting essentially of” limits the scope of a claim to the expressly recited elements, limitations, steps, integers, and/or features and any other elements, limitations, steps, integers, and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps, integers, and/or features specifically recited in the claim, whereas the meaning of the closed-ended transitional phrase “consisting essentially of” is being defined as only including those elements, limitations, steps, integers, and/or features specifically recited in the claim and those elements, limitations, steps, integers, and/or features that do not materially affect the basic and novel characteristic(s) of the claimed subject matter. Therefore, the open-ended transitional phrase “comprising” (and equivalent open-ended transitional phrases thereof) includes within its meaning, as a limiting case, claimed subject matter specified by the closed-ended transitional phrases “consisting of” or “consisting essentially of.” As such, the embodiments described herein or so claimed with the phrase “comprising” expressly and unambiguously provide description, enablement, and support for the phrases “consisting essentially of” and “consisting of.”

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

Any claims intended to be treated under 35 U.S.C. § 112 (f) will begin with the words “means for,” but use of the term “for” in any other context is not intended to invoke treatment under 35 U.S.C. § 112 (f). Accordingly, Applicant reserves the right to pursue additional claims after filing this application, in either this application or in a continuing application.

It should be understood that the methods and the order in which the respective elements of each method are performed are purely exemplary. Depending on the implementation, they may be performed in any order or in parallel, unless indicated otherwise in the present disclosure.

Finally, all patents, patent publications, and other references cited and identified in the present specification are individually and expressly incorporated herein by reference in their entirety to the same extent as if each individual publication or patent application were specifically and individually indicated to be incorporated by reference. These publications are provided solely for their disclosure prior to the filing date of the present application. The reference to any prior art in this specification is not, and should not be taken as, an acknowledgement or any form of suggestion that the prior art forms part of the common general knowledge from any country. In addition, where a definition or use of a term in an incorporated reference is inconsistent or contrary to the definition of that term provided herein, the definition of that term provided herein applies and the definition of that term in the reference does not apply. Lastly, nothing in this regard is or should be construed as an admission that the inventors are not entitled to antedate such disclosure by virtue of prior invention or for any other reason. All statements as to the date or representation as to the contents of these documents are based on the information available to the applicant and do not constitute any admission as to the correctness of the dates or contents of these documents.

1. A handled implement support assembly comprising:
a handled implement including a handle component, the handle component having a length with a proximal end and a distal end opposite the proximal end, and a handle component longitudinal axis; and
an implement support component including a handle opening and having an implement support component longitudinal axis, the implement support component being detachably connected to the handle component;
wherein, when assembled in a hand-held configuration, the implement support component is connected to the handle component with the implement support component longitudinal axis oriented substantially parallel with the handle component longitudinal axis; and
wherein, when assembled in a surface-supported configuration, the handle component is inserted into the handle opening of the implement support component with the implement support component longitudinal axis oriented transversely to the handle component longitudinal axis, such that the implement support component and the handle component form a stand that supports the handled implement on a surface.

2. The handled implement support assembly of claim 1 wherein, when assembled in a hand-held configuration, the handle component fits into the implement support component.

3. The handled implement support assembly of claim 1 wherein the implement support component is a U-shaped structure comprising a base portion, a first prong, and a second prong, the first prong spaced apart from the second prong by the base portion, with the first and second prongs each perpendicularly extending from the base portion.

4. The handled implement support assembly of claim 3 wherein a groove is formed on an inner surface of the first prong, the base portion, and the second prong, the groove slidably receiving therein an edge portion of the handle component when assembled in hand-held configuration.

5. The handled implement support assembly of claim 4, further comprising a snap fit joint configured to releasably hold the implement support component to the handle component when assembled in hand-held configuration.

6. The handled implement support assembly of claim 4, wherein the edge portion of the handle component includes a first notch opposing a second notch, and
when assembled in hand-held configuration, a first protrusion located on the first prong within the groove releasably engages with the first notch to form a first snap fit joint and a second protrusion located on the second prong within the groove releasably engages with the second notch to form a first snap fit joint, thereby securing the implement support component to the handle component, and
when assembled in surface-supported configuration, the handle opening releasably engages with the first notch and the second notch when the handle component is inserted within the handle opening to hold the handled implement in a first position.

7. The handled implement support assembly of claim 3 wherein a first end portion of the first prong is arranged distally from the base portion and a second end portion of the second prong is arranged distally from the base portion.

8. The handled implement support assembly of claim 7, wherein, when assembled in the surface-supported configuration, the distal end of the handle component, the first end portion of the first prong, and the second end portion of the second prong all contact a support surface to form a tripod.

9. The handled implement support assembly of claim 8, wherein the edge portion of the handle component further includes a third notch opposing a fourth notch,
when assembled in hand-held configuration, a first protrusion located on the first prong within the groove releasably engages with the third notch to form a third snap fit joint and a second protrusion located on the second prong within the groove releasably engages with the fourth notch to form a fourth snap fit joint, thereby securing the implement support component to the handle component and extending the length of the handle component, and
when assembled in surface-supported configuration, the handle opening releasably engages with the third notch and the fourth notch when the handle component is inserted within the handle opening to hold the handled implement in a second position.

10. A hand-held mirror support assembly comprising:
a hand-held mirror comprising a handle component, a frame component and a mirror, the handle component having a length with a proximal end and a distal end opposite the proximal end, and an edge portion, and having a handle component longitudinal axis; the frame component located at the proximal end of the handle component and the mirror being supported by the frame component; and
an implement support having an implement support component longitudinal axis, the implement support component configured as a U-shaped structure comprising a base portion including a handle opening, a first prong, and a second prong, the first prong spaced apart from the second prong by the base portion, with the first and second prongs each perpendicularly extending from the base portion, wherein a groove is formed on an inner surface of the first prong, the base portion, and the second prong, the groove configured to slidably receive therein the edge portion of the handle component when assembled in hand-held configuration
wherein the implement support component is detachably connected to the handle component;
wherein, when assembled in a hand-held configuration, the implement support component is connected to the handle component with the edge portion of handle component fitted at least partially within the groove and the implement support component longitudinal axis oriented substantially parallel with the handle component longitudinal axis; and
wherein, when assembled in a surface-supported configuration, the handle component is inserted into the handle opening of the implement support component with the implement support component longitudinal axis oriented transversely to the handle component longitudinal axis, such that the implement support component and the handle component form a stand that supports the hand-held mirror on a surface.

11. The hand-held mirror support assembly of claim 10 further comprising a snap fit joint configured to releasably hold the implement support component to the handle component when assembled in hand-held configuration.

12. The hand-held mirror support assembly of claim 11, wherein the snap fit joint comprises a first protrusion located on the first prong within the groove opposing a second protrusion located on the second prong within the groove and a first notch located on the edge portion of the handle component opposing a second notch located on the edge portion of the handle component, the first protrusion being positioned within the first notch and the second protrusion being positioned within the second notch.

13. The hand-held mirror support assembly of claim 10, wherein the edge portion of the handle component includes a first notch opposing a second notch, and
when assembled in hand-held configuration, a first protrusion located on the first prong within the groove releasably engages with the first notch to form a first snap fit joint and a second protrusion located on the second prong within the groove releasably engages with the second notch to form a first snap fit joint, thereby securing the implement support component to the handle component, and
when assembled in surface-supported configuration, the handle opening releasably engages with the first notch and the second notch when the handle component is inserted within the handle opening to hold the hand-held mirror in a first position.

14. The hand-held mirror support assembly of claim 13, wherein the edge portion of the handle component further includes a third notch opposing a fourth notch,
when assembled in hand-held configuration, a first protrusion located on the first prong within the groove releasably engages with the third notch to form a third snap fit joint and a second protrusion located on the second prong within the groove releasably engages with the fourth notch to form a fourth snap fit joint, thereby securing the implement support component to the handle component and extending the length of the handle component, and
when assembled in surface-supported configuration, the handle opening releasably engages with the third notch and the fourth notch when the handle component is inserted within the handle opening to hold the hand-held mirror in a second position.

15. The hand-held mirror support assembly of claim 13, wherein the edge portion of the handle component further includes a fifth notch opposing a sixth notch,
when assembled in hand-held configuration, a first protrusion located on the first prong within the groove releasably engages with the fifth notch to form a fifth snap fit joint and a second protrusion located on the second prong within the groove releasably engages with the sixth notch to form a sixth snap fit joint, thereby securing the implement support component to the handle component and extending the length of the handle component, and
when assembled in surface-supported configuration, the handle opening releasably engages with the fifth notch and the sixth notch when the handle component is inserted within the handle opening to hold the hand-held mirror in a third position.

16. The hand-held mirror support assembly of claim 10, wherein a first end portion of the first prong is arranged distally from the base portion and a second end portion of the second prong is arranged distally from the base portion.

17. The hand-held mirror support assembly of claim 16, wherein, when assembled in the surface-supported configuration, the distal end of the handle component, the first end portion of the first prong, and the second end portion of the second prong all contact a support surface to form a tripod.

18. A method of assembling a hand-held mirror support assembly in a surface-supported configuration, the method comprising:
providing a hand-held mirror support assembly as defined in claim 10:
inserting the handle component into the handle opening of the implement support component to transition into a surface-supported configuration where the implement support component longitudinal axis is oriented transversely to the handle component longitudinal axis, such that the implement support component and the handle component form a stand that supports the hand-held mirror on a surface.

19. The method of claim 18, wherein the edge portion of the handle component includes a first notch opposing a second notch, and the handle opening releasably engages with the first notch and the second notch when the handle component is inserted within the handle opening to hold the hand-held mirror in a first position.

20. The method of claim 19, wherein the edge portion of the handle component further includes a third notch opposing a fourth notch, and the handle opening releasably engages with the third notch and the fourth notch when the handle component is inserted within the handle opening to hold the hand-held mirror in a second position.
